(19) United States
(12) Patent Application Publication
(10) Pub. No.: US 2002/0037376 A1
(43) Pub. Date: Mar. 28, 2002

(54) Heat shrinkable article shielding against EMI and RFI

(76) Inventor: Ernest R. Fenton, Topsfield, MA (US)

Correspondence Address: Evelyn M. Sommer, Esq., PATTERSON, BELKNAP, WEBB & TYLER LLP, 1133 Avenue of the Americas, New York, NY, 10036-6710, US

(21) Appl. No.: 09/947,995

(22) Filed: Sep. 6, 2001

Related U.S. Application Data
(60) Provisional application No. 60/231,292, filed on Sep. 8, 2000.

(51) Int. Cl. B32B 1/08

(52) U.S. Cl. 428/34.9; 428/381; 428/36.9

(57) ABSTRACT

Heat shrinkable compositions comprising metal plated carbon, glass, polymer or metal fibers incorporated into an insulating polymer matrix in an amount effective to shield against EMI and RFI, articles made therefrom and methods of producing such articles.

This application claims the priority of Provisional Application Serial No. 60/231,292 filed Sep. 8, 2000.

The present invention relates to an article, specifically heat shrinkable articles and molded shapes, which are shielded against electromagnetic interference (EMI) and radio frequency interference (RFI) by a coating or layer that includes metal plated conductive fibers.

The increased use and sensitivity of electronics has led to a need for materials that protect against EMI and RFI. Presently, various types of wires and cables, including coaxial cables, utilize a metal foil or woven, served, or braided wire filaments as an electrically conductive shielding layer to inhibit interfering signals from reaching the center conductor. In other shielding applications, metal coated fibers in which the base fiber is carbon, graphite, fiberglass, aramid, stainless steel, or steel nano-fibers have been used as discontinuous fillers molded in an insulating matrix into rigid shielding structures.

The shielding effectiveness of such discontinuous fillers is known to be directly proportional to the amount of filler used. Therefore, while shielding properties increase with increasing amounts of filler, other non-desirable properties, such as stiffness and weight of the resulting product also increase. Accordingly, the material not only becomes difficult to fabricate, but the resulting shield structure loses its ability to bend or twist without creating shielding gaps, or “windows,” thus rendering objects enclosed within the shield structure susceptible to EMI and RFI. Thus, while discontinuous fiber-based shielding material may find uses in molded structures, its use in heat shrinkable articles to insulate wires and cables is limited. It would be desirable to provide a shielding structure incorporating discontinuous fibers which can be easily manipulated and incorporated into a polymeric material that would heat shrink to conform to the surface of a wire or cable or connector backshells to provide lower-cost wires, cables, and cable assemblies shielded against EMI and RFI.

To solve the above-mentioned problems and disadvantages associated with the prior art, the present invention utilizes metal plated conductive fibers as an integral part of a heat shrinkable layer, rather than a separate layer. This new heat shrinkable shielding layer can be used alone or in combination with a conventional metal shielding layer. The small diameter of such metal plated fibers enables a large amount of metal plated fiber to be incorporated into the shielding layer, which increases shielding effectiveness. As a result, the product may be installed only in particular areas where EMI/RFI problems exist, without affecting non-problematic areas. The present invention allows the application of heat shrink tape, for example, to attenuate or remove cross-talk between adjacent wires that do not lend itself to traditional installation of heat shrink tubing. Unlike the prior art, therefore, the present invention offers improved shielding effectiveness. Because the invention can be manufactured at relatively high rates, the cost of such an article is reduced.

### SUMMARY OF THE INVENTION

Accordingly, the present invention is a heat shrinkable composition used to form an article which combines metal plated fibers and a heat shrinkable material in the form of a tube, tape, molded shape or end cap. The metal plated fiber can be incorporated on either the inner or outer surface, or within the heat shrinkable material itself, when a dual wall article is formed, for example.

In another aspect, the invention provides a method of producing an article comprising an inner conductor formed of at least one electrically conductive wire, an insulating layer surrounding the inner conductor; and a heat shrinkable shielding layer surrounding the insulating layer. The heat shrinkable shielding layer comprises a plurality of metal plated fibers in an insulating polymer matrix, the metal plated fibers being present in an amount effective to shield against EMI and RFI. The method comprises extruding the insulating layer over the wire; and applying the heat shrink article as a shielding layer over the insulating layer and wire.

### DETAILED DESCRIPTION OF THE INVENTION

The present invention is directed to a heat shrinkable composition comprising a plurality of metal plated fibers in an insulating polymer matrix, the metal plated fibers being present in an amount effective to shield against EMI and RFI. The invention can be used to form a heat shrinkable article, that includes but is not limited to a tape, tubing, molded shape or end cap. The article may also comprise an outer jacket of insulating material.

Cross-linked polymers used in heat shrinkable applications are well-known in the art. For example, the Cook patent, U.S. Pat. No. 3,086,242, which is incorporated by reference into this application in its entirety, teaches suitable polymers and methods for making the same. This reference also describes the mechanism by which heat shrinking is accomplished.

It has been found that an article comprising metal plated fiber in an amount up to about 50%, preferably about 35% by weight of the polymer matrix, enables the article to be fabricated using an extrusion process. The metal plated fiber of the present invention comprises a core material of carbon, glass, polymer or metal, which is covered with a fiber layer formed of material selected from the group consisting of electroplated metal, chemical vapor deposited metal, and electroless plated metal. The method of coating and the use of such metal coated fibers are described in U.S. Pat. Nos. 4,680,093, 4,609,449 and 4,661,403, the entire contents of which are incorporated by reference herein. Preferably, the core material comprises aramid, fiberglass, graphite, stainless steel.

Therefore, an article fabricated with a heat shrinkable layer comprising a metal plated fiber in an insulating polymer matrix is not only lighter in weight than traditional articles having a separate metal shield layer, but it also has improved flexibility and shielding properties over these traditional articles.

It has also been shown that when the metal plated fibers are coated with a sizing agent and cut to a length of from about 20 microns to about 65 millimeter before incorporation into the polymer matrix, improvement is realized in both the process and the resulting properties. The wetting properties between the metal coated fibers and the polymer matrix are enhanced when a coating formed of a sizing agent is applied to the metal plated fibers before they are incorporated into the polymer matrix. The sizing agents that are used are conventional and well known to the skilled in the art.

It has further been discovered that a length-to-diameter aspect ratio of at least 700, preferably about 780, for the metal coated fibers allows the material to be extruded at high speeds by cross-head or other well-known extrusion techniques. Crosshead extrusion is primarily used when extruding a dual wall, heat shrinkable article. In addition, the layer comprising a metal plated fiber in an insulating polymer matrix may be extruded in the form of a tape, which can then be cross-linked and expanded to make it heat shrinkable. This heat shrinkable EMI/RFI tape can then be helically or a longitudinally wrapped around the dielectric or around the optional woven, braided, or served metal layer. Upon the application of heat, the heat shrinkable tape will recover to conform with the substrate under it to form a shielding layer.

Improvements in the previously described properties are realized by incorporating a conductive material, in addition to a metal plated fiber, into the insulating polymer matrix. Again, the metal plated fibers are present in an amount effective to shield against EMI and RFI. Preferably, the conductive material includes conductive powders, uncoated graphite fibers, and metal powders. More preferably, the conductive material comprises carbon black. By adding such conductive materials to the insulating polymer matrix, it is possible to minimize the amount of the more expensive metal plated fibers, without sacrificing shielding properties. Alternatively, by adding conductive powders without decreasing the amount of metal plated fibers, a synergistic improvement in mechanical and shielding properties is realized. A preferred embodiment incorporating this improvement would comprise a first shielding layer surrounding the insulating layer, wherein the first shielding layer comprises a plurality of metal plated fibers in a matrix, the matrix comprising an insulating polymer and a conductive filler material.

It has been discovered that the step of extruding the heat shrinkable tubing can comprise feeding a continuous length of metal plated fiber or metal plated fiber in the form of chopped metal fibers into an extruder during extrusion. Alternatively, the step of extruding the heat shrinkable tubing can comprise first compounding the metal plated fiber into a compound pellet and adding the compound pellet to an extruder during extrusion. Such a compounding step includes mixing the metal plated fibers with a polymeric material and subsequently forming a pellet.

The present invention has been disclosed generally and by reference to embodiments thereof. The scope of the invention is not limited to the disclosed embodiments but is defined by the appended claims and their equivalents.

What is claimed is:

1. A heat shrinkable composition comprising a plurality of metal plated fibers in an insulating polymer matrix, the metal plated fibers being present in an amount effective to shield against EMI and RFI.

2. The composition of claim 1, wherein the metal plated fibers are present in an amount up to about 50% by weight of said composition.

3. The composition of claim 2, wherein the metal plated fibers are present in an amount of about 35% by weight of said composition.

4. The composition of claim 1, wherein the metal plated fibers comprise a core material selected from the group consisting of carbon, glass, polymer, and metal.

5. The composition of claim 4, wherein the metal plated fibers comprise a core material covered with a metal layer formed of material selected from the group consisting of electroplated metal, chemical vapor deposited metal, and electroless plated metal.

6. The composition of claim 1, wherein the metal plated fibers comprise a core material selected from the group consisting of aramid, fiberglass, graphite, stainless steel.

7. The composition of claim 1, wherein the metal plated fibers comprise a coating formed of a sizing agent applied before the metal plated fibers are incorporated into the polymer matrix.

8. The composition of claim 7, wherein the metal plated fibers are cut to a length from about 20 microns to about 65 millimeters after being coated and before being incorporated into the polymer matrix.

9. The composition of claim 1, wherein the metal plated fibers have a length to diameter aspect ratio of at least 700.

10. The composition of claim 1, wherein the metal plated fibers have a length to diameter aspect ratio of at least 780.

11. The composition of claim 1, wherein a conductive material in addition to said metal plated fibers is incorporated into the polymer matrix.

12. The composition of claim 11 wherein the conductive material is selected from uncoated graphite fibers and metal powders.

13. The composition of claim 11 wherein the conductive material is carbon black.

14. An article made from the composition of claim 1.

15. The article of claim 14, which is in the form of a tape, tubing, molded shape or end cap.

16. Method for producing an article comprising an inner conductor formed of at least one electrically conductive wire, an insulating layer surrounding the inner conductor, and a heat shrinkable shielding layer surrounding the insulating layer which comprises extruding the insulating layer over an article made from the composition according to claim 14, applying the insulating layer over the wire and applying the heat shrinkable shielding layer over the insulating layer and wire.
